(19) United States
(12) Patent Application Publication
(10) Pub. No.: US 2013/0152894 A1
(43) Pub. Date: Jun. 20, 2013

(54) STOP/START ENGINE GLOW PLUG HEATER CONTROL

(71) Applicants: Viet Quoc To, West Bloomfield, MI (US); Brien Lloyd Fulton, West Bloomfield, MI (US); John Richard Blankenship, Dearborn, MI (US)

(72) Inventors: Viet Quoc To, West Bloomfield, MI (US); Brien Lloyd Fulton, West Bloomfield, MI (US); John Richard Blankenship, Dearborn, MI (US)

(73) Assignee: FORD GLOBAL TECHNOLOGIES, LLC, Dearborn, MI (US)

(21) Appl. No.: 13/326,069

(22) Filed: Dec. 14, 2011

(51) Int. Cl. F02N 19/02; F02P 19/02

(52) U.S. Cl. 123/179.21

(57) ABSTRACT

Methods and systems for operating a glow plug are disclosed. In one example, glow plugs of a compression ignition engine are selectively operated during automatic engine starting. The methods and systems may be useful to reduced glow plug degradation and improve emissions of an automatically started engine.

### BACKGROUND/SUMMARY

A diesel engine compresses an air-fuel mixture to initiate combustion. The air-fuel mixture automatically ignites without a dedicated ignition source such as a spark plug when there is sufficient temperature and pressure within the cylinder. Providing an environment within the cylinder that is conducive to compression ignition combustion may be desirable during engine starting and for a period of time after the engine is started. One way to improve conditions within a diesel engine cylinder to promote automatic ignition is to install a glow plug into the cylinder. Each time the engine is started, the glow plug heats a portion of the cylinder and provides a localized area within the cylinder where temperature in the cylinder is increased to facilitate compression ignition and combustion in the cylinder. Another way to improve conditions in the cylinder for automatic ignition is to raise a temperature of air entering engine cylinders via a grid heater. The grid heater is activated during each engine start to raise a temperature of air entering the engine cylinder so that an air-fuel mixture within the cylinder can approach its automatic ignition temperature when the air-fuel mixture is compressed. In these ways, automatic ignition of a compression ignition engine may be promoted during engine starting. However, if the engine is started and stopped at frequent intervals, the glow plug and/or grid heater may degrade due to more frequent activation.

The inventors herein have recognized the above-mentioned disadvantages and have developed a method for operating an engine, comprising: automatically stopping an engine without a dedicated driver request to stop the engine; and selectively activating a first heater that heats contents of an engine cylinder during an automatic engine start, the automatic engine start initiated without a dedicated driver engine start request.

By selectively activating a device that heats contents of a cylinder during automatic engine starting and stopping, it may be possible to reduce heater degradation since the heater may be exposed to fewer instances where current rushes into the heater during activation. Additionally, the heater may be reactivated during automatic engine starting conditions where it may be desirable to heat contents of the cylinder to improve engine starting and reduce engine emissions. In this way, a glow plug and/or grid heater may be selectively operated to improve engine emissions and starting as well as to reduce degradation of the glow plug and/or grid heater.

The present description may provide several advantages. For example, the approach may provide reduced heater degradation by inhibiting heater operation during frequent engine stops and starts where operation of the heater may provide few benefits. Additionally, the approach may reduce engine emissions by activating the heater when the possibility of engine misfire increases during engine starting.

The above advantages and other advantages, and features of the present description will be readily apparent from the following Detailed Description when taken alone or in connection with the accompanying drawings.

It should be understood that the summary above is provided to introduce in simplified form a selection of concepts that are further described in the detailed description. It is not meant to identify key or essential features of the claimed subject matter, the scope of which is defined uniquely by the claims that follow the detailed description. Furthermore, the claimed subject matter is not limited to implementations that solve any disadvantages noted above or in any part of this disclosure.

### BRIEF DESCRIPTION OF THE FIGURES

FIG. 1 shows a schematic depiction of an engine;

FIGS. 2 and 3 show simulated heater operating sequence during repeated engine starting and stopping; and

FIG. 4 shows a flowchart of an example method for operating heaters for improving combustion in a compression ignition engine.

### DETAILED DESCRIPTION

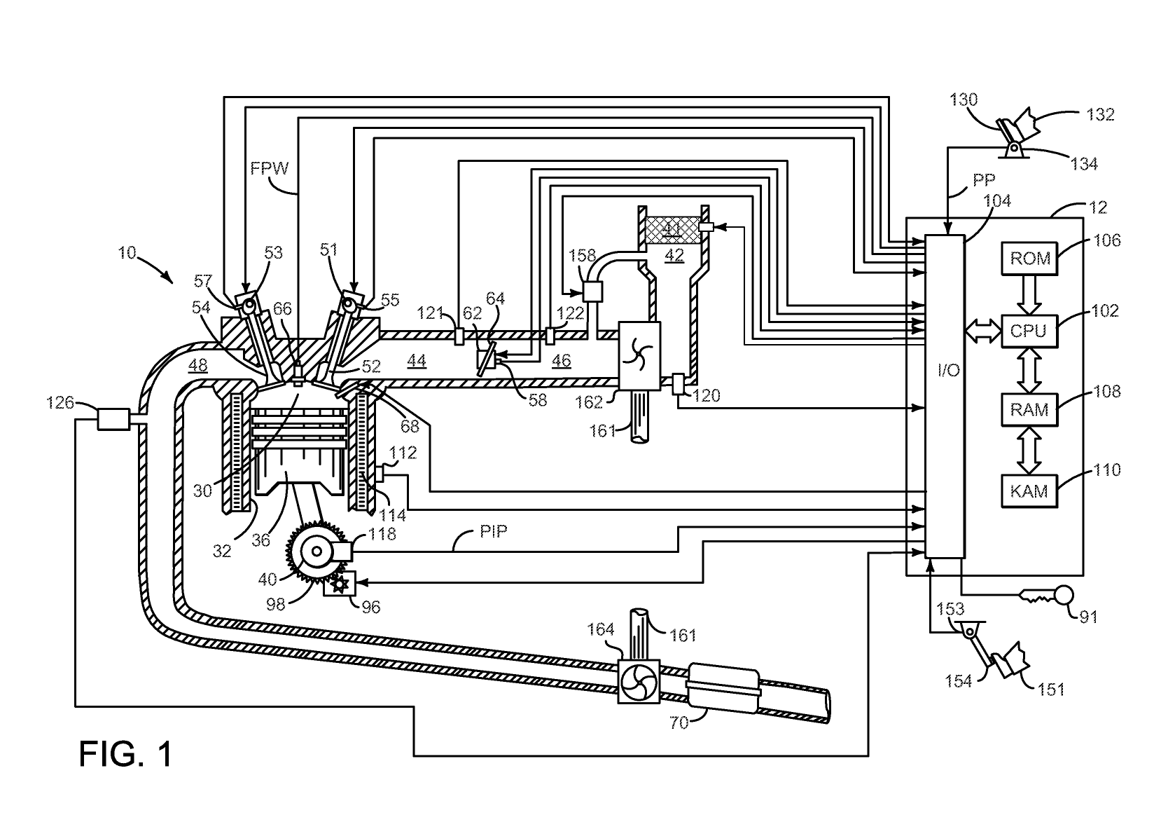

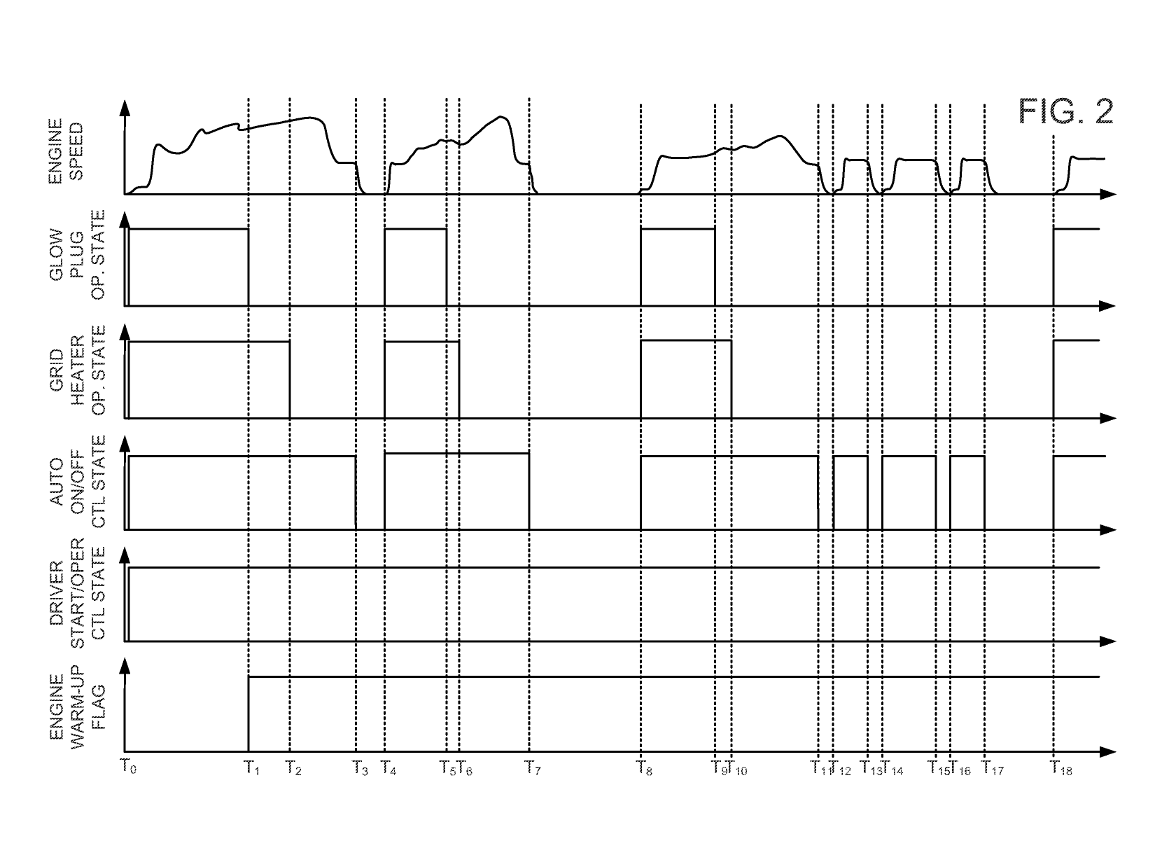

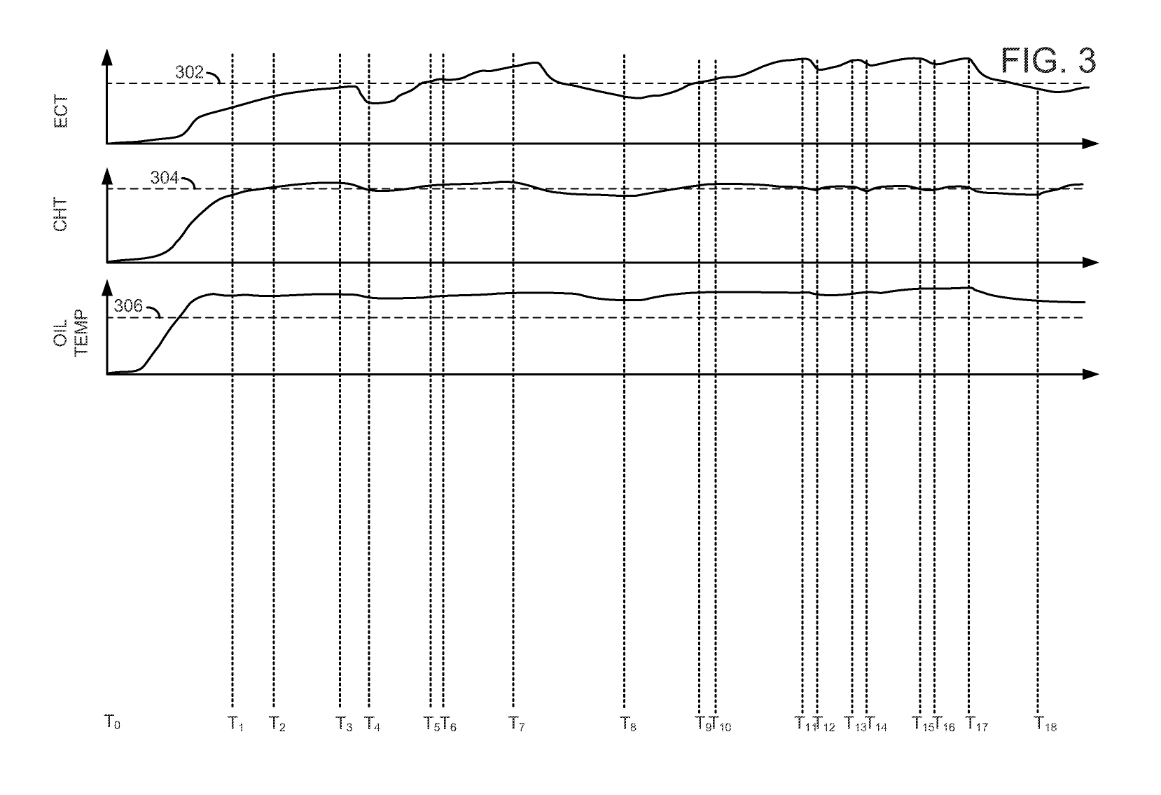

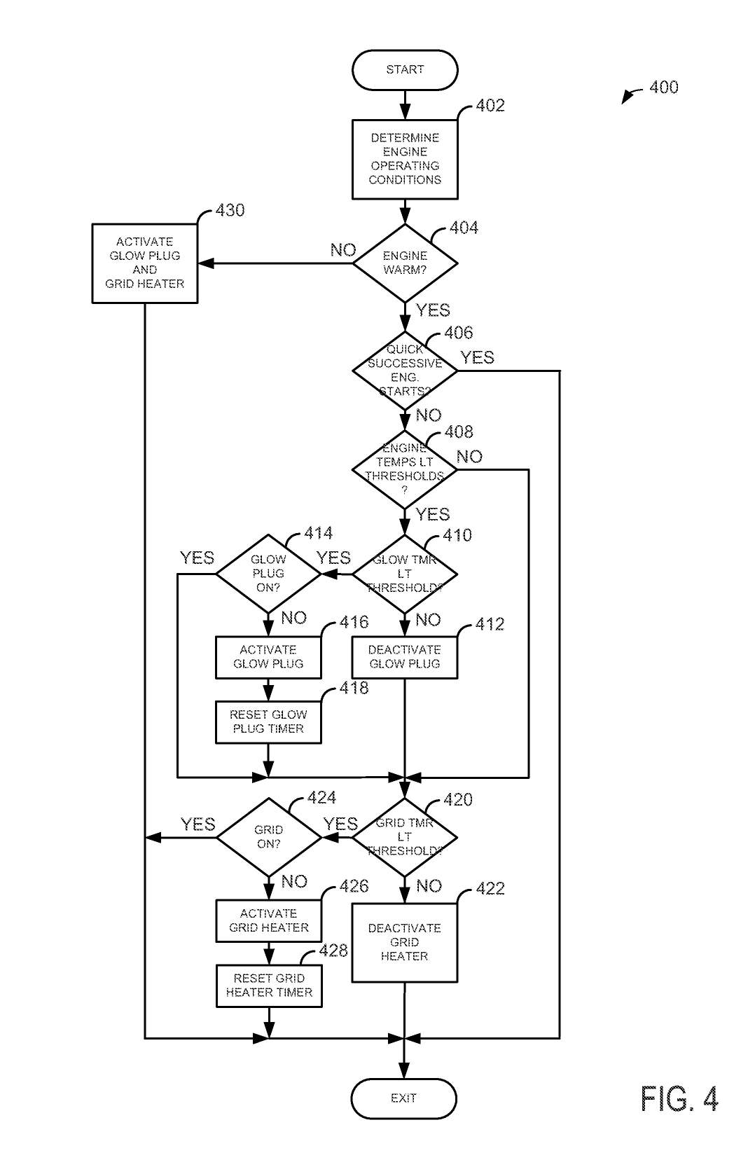

The present description is related to improving engine operation via selectively operating glow plugs and/or an engine air inlet grid heater. Automatic engine stopping and starting may be implemented in a vehicle system to conserve fuel supplied to an engine. FIG. 1 shows one example of an automatically stopped and started compression ignition engine. The engine system of FIG. 1 may be operated as shown in FIGS. 2 and 3 according to the method of FIG. 4.

Referring to FIG. 1, internal combustion engine 10, comprising a plurality of cylinders, one cylinder of which is shown in FIG. 1, is controlled by electronic engine controller 12. Engine 10 includes combustion chamber 30 and cylinder walls 32 with piston 36 positioned therein and connected to crankshaft 40. Combustion chamber 30 is shown communicating with intake manifold 44 and exhaust manifold 48 via respective intake valve 52 and exhaust valve 54. Each intake and exhaust valve may be operated by an intake cam 51 and an exhaust cam 53. The position of intake cam 51 may be determined by intake cam sensor 55. The position of exhaust cam 53 may be determined by exhaust cam sensor 57.

Fuel injector 66 is shown positioned to inject fuel directly into combustion chamber 30, which is known to those skilled in the art as direct injection. Fuel injector 66 delivers fuel in proportion to the pulse width of signal FPW from controller 12. Fuel is delivered to fuel injector 66 by a fuel system (not shown) including a fuel tank, fuel pump, fuel rail (not shown). Fuel pressure delivered by the fuel system may be adjusted by varying a position valve regulating flow to a fuel pump (not shown). In addition, a metering valve may be located in or near the fuel rail for closed loop fuel control. A pump metering valve may also regulate fuel flow to the fuel pump, thereby reducing fuel pumped to a high pressure fuel pump.

Intake manifold 44 is shown communicating with optional electronic throttle 62 which adjusts a position of throttle plate 64 to control air flow from intake boost chamber 46. Compressor 162 draws air from air intake inlet 42 to supply boost chamber 46. Exhaust gases spin turbine 164 which is coupled to compressor 162 via shaft 161. In some examples, a charge air cooler may be provided. Grid heater 41 heats ambient air that enters the engine air inlet 42 by converting electrical energy into thermal energy. In other examples, grid heater 41 may be positioned downstream of compressor 162. Compressor bypass valve 158 allows compressed air at the outlet of compressor 162 to be returned to the input of compressor 162. In this way, the efficiency of compressor 162 may be reduced so as to affect the flow of compressor 162 and reduce intake manifold pressure.

Combustion is initiated in combustion chamber 30 when fuel automatically ignites as piston 36 approaches top-dead-center compression stroke. In some examples, a universal Exhaust Gas Oxygen (UEGO) sensor 126 may be coupled to exhaust manifold 48 upstream of emissions device 70. In other examples, the UEGO sensor may be located downstream of one or more exhaust after treatment devices. Further, in some examples, the UEGO sensor may be replaced by a NOx sensor that has both NOx and oxygen sensing elements.

At lower engine temperatures glow plug 68 may convert electrical energy into thermal energy so as to raise a temperature in combustion chamber 30. By raising temperature of combustion chamber 30, it may be easier to ignite a cylinder air-fuel mixture via compression.

Emissions device 70 can include a particulate filter and catalyst bricks, in one example. In another example, multiple emission control devices, each with multiple bricks, can be used. Emissions device 70 can include an oxidation catalyst in one example. In other examples, the emissions device may include a lean NOx trap or a selective catalyst reduction (SCR), and/or a diesel particulate filter (DPF).

Engine starter 96 may be comprised of an electric motor that rotates flywheel 98 which is coupled to crankshaft 40. Controller 12 selectively operates starter 96 by supplying current to starter 96 via a battery or other energy storage device (not shown).

Controller 12 is shown in FIG. 1 as a conventional microcomputer including: microprocessor unit 102, input/output ports 104, read-only memory 106, random access memory 108, keep alive memory 110, and a conventional data bus. Controller 12 is shown receiving various signals from sensors coupled to engine 10, in addition to those signals previously discussed, including: engine coolant temperature (ECT) from temperature sensor 112 coupled to cooling sleeve 114; a position sensor 134 coupled to an accelerator pedal 130 for sensing accelerator position adjusted by foot 132; a position sensor 153 coupled to an brake pedal 154 for sensing accelerator position adjusted by foot 151; a dedicated driver engine start input 91 (e.g., a key or a pushbutton); a measurement of engine manifold pressure (MAP) from pressure sensor 121 coupled to intake manifold 44; boost pressure from pressure sensor 122 exhaust gas oxygen concentration from oxygen sensor 126; an engine position sensor from a Hall effect sensor 118 sensing crankshaft 40 position; a measurement of air mass entering the engine from sensor 120 (e.g., a hot wire air flow meter); and a measurement of throttle position from sensor 58. Barometric pressure may also be sensed (sensor not shown) for processing by controller 12. In a preferred aspect of the present description, engine position sensor 118 produces a predetermined number of equally spaced pulses every revolution of the crankshaft from which engine speed (RPM) can be determined.

During operation, each cylinder within engine 10 typically undergoes a four stroke cycle: the cycle includes the intake stroke, compression stroke, expansion stroke, and exhaust stroke. During the intake stroke, generally, the exhaust valve 54 closes and intake valve 52 opens. Air is introduced into combustion chamber 30 via intake manifold 44, and piston 36 moves to the bottom of the cylinder so as to increase the volume within combustion chamber 30. The position at which piston 36 is near the bottom of the cylinder and at the end of its stroke (e.g. when combustion chamber 30 is at its largest volume) is typically referred to by those of skill in the art as bottom dead center (BDC). During the compression stroke, intake valve 52 and exhaust valve 54 are closed. Piston 36 moves toward the cylinder head so as to compress the air within combustion chamber 30. The point at which piston 36 is at the end of its stroke and closest to the cylinder head (e.g. when combustion chamber 30 is at its smallest volume) is typically referred to by those of skill in the art as top dead center (TDC). In a process hereinafter referred to as injection, fuel is introduced into the combustion chamber. In some examples, fuel may be injected to a cylinder a plurality of times during a single cylinder cycle. In a process hereinafter referred to as ignition, the injected fuel is ignited by compression ignition resulting in combustion. During the expansion stroke, the expanding gases push piston 36 back to BDC. Crankshaft 40 converts piston movement into a rotational torque of the rotary shaft. Finally, during the exhaust stroke, the exhaust valve 54 opens to release the combusted air-fuel mixture to exhaust manifold 48 and the piston returns to TDC. Note that the above is described merely as an example, and that intake and exhaust valve opening and/or closing timings may vary, such as to provide positive or negative valve overlap, late intake valve closing, or various other examples. Further, in some examples a two-stroke cycle may be used rather than a four-stroke cycle.

Thus, the system of FIG. 1 provides for: an engine; a glow plug positioned in a cylinder of the engine; a dedicated driver operated engine starting input device; a driver vehicle control input device; and a controller including instructions to start the engine in response to an operator changing a state of the dedicated driver operated engine starting input device, and instructions to automatically activate the glow plug and start the engine without the operator changing the state of the dedicated driver operated engine starting input device and in response to a state of the driver vehicle control input device.

The system also includes where the driver vehicle control input device is a brake pedal or an accelerator pedal. The system further comprises a grid heater and further controller instructions for automatically activating the grid heater and start the engine without the operator changing the state of the dedicated driver operated engine starting input device and in response to the state of the driver vehicle control input device. The system further comprises additional controller instructions to not activate the glow plug during automatic engine starting where the operator has not changed the state of the dedicated driver operated engine starting input device. The system further comprises additional controller instructions to automatically stop the engine. In some examples, the system further comprises additional controller instructions to selectively activate the glow plug in response to a temperature of the engine during automatic engine starting.

Referring now to FIGS. 2 and 3, a simulated heater operating sequence during repeated engine starting and stopping is shown. The sequence of FIGS. 2 and 3 may be provided by the system shown in FIG. 1 executing instructions according to the method of FIG. 4.

The first plot from the top of FIG. 2 represents engine speed versus time. The X axis represents time and time increases from the left to right side of the plot. The Y axis represents engine speed and engine speed increased in the direction of the Y axis arrow.

The second plot from the top of FIG. 2 represents glow plug state versus time. The X axis represents time and time increases from the left to right side of the plot. The Y axis represents glow plug state. The glow plug is on when the glow plug state is a higher level. The glow plug is off when the glow plug state is at a low level near the X axis.

The third plot from the top of FIG. 2 represents grid heater state versus time. The X axis represents time and time increases from the left to right side of the plot. The Y axis represents grid heater state. The grid heater is on when the grid heater state is at a higher level. The grid heater is off when the grid heater state is at a low level near the X axis.

The fourth plot from the top of FIG. 2 represents automatic engine start/stop control state versus time. The X axis represents time and time increases from the left to right side of the plot. The Y axis represents automatic engine start/stop control state. The automatic engine start/stop control state indicates that the engine is started or is to be automatically started (e.g., at a transition from a low state to a high state) when the automatic engine stop/start control state is at a higher level. The engine is off or commanded off (e.g., at a transition from a high state to a low state) when the automatic engine stop/start control state is at a low level near the X axis.

The fifth plot from the top of FIG. 2 represents a driver engine start/operate state versus time. The X axis represents time and time increases from the left to right side of the plot. The Y axis represents driver engine start/operate control state. The driver engine start/stop control state indicates that the engine is started or is to be started according to the driver request (e.g., at a transition from a low state to a high state) when the driver engine stop/start control state is at a higher level. The engine is off or commanded off by the driver (e.g., at a transition from a high state to a low state) when the driver engine stop/start control state is at a low level near the X axis.

The sixth plot from the top of FIG. 2 represents whether or not the controller has determined when the engine has reached a warmed up state. The X axis represents time and time increases from the left to right side of the plot. The Y axis represents engine warm-up state. The engine is determined to be warmed-up when the engine warm-up flag is at a higher level. The engine is not determined to be warmed-up when the engine warm-up flag is at a low level near the X axis.

The first plot from the top of FIG. 3 represents engine coolant temperature (ECT) versus time. The X axis represents time and time increases from the left to right side of the plot. The Y axis represents engine coolant temperature. Engine coolant temperature increases in the direction of the Y axis. Horizontal line 302 represents a threshold engine coolant temperature.

The second plot from the top of FIG. 3 represents cylinder head temperature (CHT) versus time. The X axis represents time and time increases from the left to right side of the plot. The Y axis represents cylinder head temperature. Cylinder head temperature increases in the direction of the Y axis. Horizontal line 304 represents a threshold cylinder head temperature.

The third plot from the top of FIG. 3 represents engine oil temperature versus time. The X axis represents time and time increases from the left to right side of the plot. The Y axis represents engine oil temperature. Engine oil temperature increases in the direction of the Y axis. Horizontal line 306 represents a threshold engine oil temperature.

At time T₀, the engine is stopped and the engine is not operating. Shortly thereafter, a driver start request is asserted via a dedicated driver input having a sole function of initiating an engine start (e.g., a key switch or push button) as indicated by the driver start/operate control state flag transitioning from a low level to a higher level. The engine glow plugs are activated as is the grid heater in response to the operator request to start the engine. The glow plug operating state flag and the grid heater operating state flag transition from a low state to a high state to indicate the glow plugs and grid heater are activated. The engine is not warm initially so the engine warm-up flag is in a low state. The engine coolant temperature, cylinder head temperature, and oil temperatures are at a low level at the time of engine starting.

Between time T₀ and time T₁, the engine is started and operated. As the engine operating time and engine load increase, the engine coolant temperature, cylinder head temperature, and oil temperature increase. The glow plugs and the grid heater also remain in an activated state so that combustion stability may be improved. In some examples, the glow plugs may be supplied a first higher level of current when the driver start/operate control state transitions to a higher level in response to the dedicated driver input. The current may then be decreased to a lower level as the engine operates and the engine temperature begins to increase. Engine coolant temperature, cylinder head temperature, and oil temperature continue to increase as engine operating time increases. The engine oil temperature exceeds the oil temperature threshold 306 before time T₁ is reached.

At time T₁, the engine warm-up flag transitions to a higher level. The operating state of the engine warm-up state flag may be based on engine temperature, time since engine stop, and other engine operating conditions. The glow plug operating state is also shown transitioning from a higher level to a lower level to indicate the glow plugs are turned off by stopping current flow to the glow plugs. In one example, the glow plugs remain on after initially being activated at least until the engine warm-up flag is set to indicate the engine is warm. The engine cylinder head temperature exceeds the cylinder head temperature threshold 304 before time T₂ is reached.

At time T₂, the grid heater operating state is transitioned from a higher level to a lower level so as to indicate that the grid heaters are turned off by stopping current flow to the grid heater. The grid heater may be deactivated in response to a time since engine stop or in response to a temperature in the engine air inlet. The automatic engine on/off control state remains asserted from shortly after time T₀ to T₂ in order to indicate that the engine should remain operating according to a scheduler that may automatically stop the engine in response to engine and vehicle operating conditions.

At time T₃, engine speed has been reduced to an idle speed and conditions are desirable for automatically stopping the engine. In one example, the engine may be automatically stopped when engine speed is less than a threshold engine speed and while the vehicle in which the engine is located is stopped. The automatic engine on/off control state transitions from a higher level to a lower level to indicate that the engine is to be stopped automatically without direct input from the driver requesting that the engine stop. Engine speed is reduced to zero shortly after the automatic engine on/off control state is transitioned to the lower level. The engine glow plugs and the grid heater remain off at the time the engine is stopped.

Between time T₃ and time T₄, the engine is stopped and the automatic on/off control state remains in a low state. The engine coolant temperature decreases after the engine is stopped and remains below engine temperature threshold 302. The cylinder head temperature decreases to less than cylinder head temperature threshold 304 after the engine is stopped. The engine oil temperature remains above the engine oil temperature threshold 306.

At time T₄, the automatic engine start/stop control state transitions from a low level to a high level to indicate that the engine is to be started automatically without a dedicated driver input that has a sole function of requesting an engine start. The automatic engine start/stop control state may change state in response to a driver lifting a brake pedal or in response to an operating state of a battery, for example. The glow plug and the grid heater are activated in response to the automatic engine start request indicated by the automatic engine start/stop control state transitioning to the higher level. The driver start/operate control state remains asserted to indicate that the driver has not requested the engine stop via a dedicated input that has sole functions of starting and/or stopping the engine. The engine warm-up state also remains high to indicate that the engine is warm when restarted automatically.

At time T₅, the glow plug operating state is transitioned from a higher level to a lower level to indicate that the glow plugs are deactivated. The glow plugs may be transitioned to an off state in response to a time since engine stop, engine coolant temperature, or other engine control parameter. The grid heater is also transitioned to an off state shortly thereafter at time T₆.

Between time T₆ and time T₇, the engine is operated without the glow plugs or grid heater being activated. The engine coolant temperature, cylinder head temperature, and engine oil temperature are above temperature thresholds 302, 304, and 306 respectively.

At time T₇, the automatic engine start/stop control state is transitioned from a higher level to a lower level to indicate an automatic engine stop request. The engine speed is reduced to zero and the engine is stopped. Between time T₇ and time T₈, the engine coolant temperature and the cylinder head temperature decrease to below threshold levels 302 and 304.

At time T₈, a request to automatically restart the engine is indicated by the automatic engine stop/start control state transitioning from a lower state to a higher state. In one example, the glow plugs may be reactivated in response to an automatic engine start request when at least one of the engine coolant temperature, engine cylinder head temperature, and engine oil temperature are lower than predetermined threshold temperatures 302, 304, and 306. In this example, both engine coolant temperature and the cylinder head temperature are below threshold levels so both the glow plugs and the grid heater are reactivated in response to the automatic engine start request. The engine starts and continues to operate between time T₈ and time T₉. In other examples, only the grid heater or glow plugs may be activated while the other remains deactivated.

At time T₉, the glow plug heaters are deactivated. Similarly, the grid heater is deactivated at time T₁₀. Engine coolant temperature, cylinder head temperature, and oil temperature are above respective threshold temperatures 302, 304, and 306 when the glow plugs and grid heaters are deactivated.

At times T₁₁-T₁₆ the engine is successively automatically stopped and restarted as indicated by the automatic engine on/off control state transitioning from a low to high state and vice-versa. Specifically, the engine is stopped at times T₁₁, T₁₃, and T₁₅. The engine is restarted at times T₁₂, T14, and T₁₆. The glow plugs and the grid heater are shown being held in an off state during successive engine stops and starts. In some examples, the glow plugs and/or the grid heater states may be maintained during quick successive automatic engine stops and starts. Engine starts may be determined to be quick and successive when a time between an engine stop request and an engine start request is less than a threshold amount of time. In other examples, quick successive starts may be determined by a temperature drop between engine stop and start requests. If an engine temperature drops less than a threshold amount between engine stop and start, the stop and start may be determined to be a quick successive stop and start. In other examples, the glow plug and/or grid heater states may be set to activated or deactivated states in response to quick successive engine stops and starts.

At time T₁₇, the engine is automatically stopped as indicated by the automatic on/off control state transitioning to a low state. The engine remains off for a longer period of time as compared to the engine off times between times T₁₁ and T₁₆. The engine coolant temperature and the engine cylinder head temperature fall below temperature thresholds 302 and 304. The glow plugs and the grid heaters are reactivated when the engine is automatically restarted at time T₁₈. The engine coolant temperature and the cylinder head temperature being below the respective thresholds allows the glow plugs and the grid heaters to be reactivated.

In this way, glow plugs and a grid heater of a diesel compression ignition engine may be operated in an automatic stop/start vehicle to improve combustion stability and emissions during engine starting. Since the glow plugs and grid heater do not have to be operated during every engine start, the life of the glow plugs and grid heater may be extended.

During driver initiated starts the glow plugs and the grid heater may be activated when engine coolant temperature is less than a threshold, when cylinder head temperature is less than a threshold, and when engine oil temperature is less than a threshold. During a driver initiate start glow plugs and the grid heater may remain off or deactivated when engine coolant temperature is greater than a threshold, when cylinder head temperature is greater than a threshold, and when engine oil temperature is greater than a threshold.

During an automatic engine start where the driver does not request an engine start via a dedicated input having a sole function of starting and stopping the engine, the glow plug heater and the grid heater may be activated when one of the engine coolant temperature being less than a threshold engine coolant temperature, the cylinder head temperature being less than a threshold engine cylinder head temperature, and the engine oil temperature is less than a threshold engine oil temperature. During an automatic engine start where the driver does not request an engine start via a dedicated input having a sole function of starting and stopping the engine, the glow plug heater and the grid heater may be deactivated when the engine coolant temperature is greater than a threshold engine coolant temperature, the cylinder head temperature is greater than a threshold engine cylinder head temperature, and the engine oil temperature is greater than a threshold engine oil temperature.

Referring now to FIG. 4, a method for operating glow plugs and grid heaters of an automatically started and stopped engine is shown. The method of FIG. 4 may provide the sequence shown in FIGS. 2 and 3 in a system such as the system shown in FIG. 1. The method of FIG. 4 may be executed via instructions of a controller such as controller 12 of FIG. 1. Further, the method of FIG. 4 may be operative in response to an automatic engine start request after an automatic engine stop request where the engine stop request and the engine start request are made via a controller absent driver or operator input from an input that has sole functions of starting and/or stopping the engine (e.g., absent an input from an engine start/stop key or button). The method of FIG. 4 may be invoked after an engine is automatically stopped.

At 402, method 400 determines engine operating conditions. Engine operating conditions may include but are not limited to engine speed, engine load, vehicle speed, brake pedal position, accelerator pedal position, engine temperature, cylinder head temperature, and engine oil temperature. Method 400 proceeds to 404 after engine operating conditions are determined.

At 404, method 400 judges whether or not the engine has warmed-up. Method 400 may judge that the engine is warm after the engine is operating for a predetermined amount of time or based on a temperature of the engine (e.g., engine coolant temperature). If method 400 judges that the engine is warm, method 400 proceeds to 406. Otherwise, method 400 proceeds to 428.

At 428, method 400 activates engine glow plugs and/or a grid heater when the engine has not reached a warmed up state. In some examples, the current supplied to the glow plugs and/or the grid heater may be adjusted based on engine operating conditions. For example, the glow plugs and/or grid heater may be supplied with a first higher current when first activated. Over time the amount of current supplied to the glow plug and/or grid heater may be reduced as the engine warms. Method 400 proceeds to exit after the glow plugs and/or grid heater are activated.

At 406, method 400 judges whether or not the engine is presently undergoing a quick successive stop and start. In one example, method 400 determines that a quick successive stop/start occurs when a time between an engine stop request and an engine start request is less than a threshold amount of time. In other examples, method 400 may consider times between engine stop requests as well as times between engine stop and start requests. For example, if the time between two engine start requests is less than a first threshold time and a time between an engine stop request and an engine start request is less than a second threshold time, method 400 may judge quick successive start/stop is present. If method 400 determines a quick successive stop/start is present, method 400 proceeds to exit. Thus, the state of the glow plugs and the grid heater may be maintained. In other examples, the state of the glow plugs and/or grid heater may be set to a desired state (e.g., on or off) when a successive engine start/stop is determined. If method 400 does not determine that successive stop/start are present, method 400 proceeds to 408.

At 408, method 400 judges whether or not engine temperatures are less than predetermine threshold temperatures. In one example, method 400 judges whether or not engine coolant temperature is less than a threshold temperature, whether or not engine cylinder head temperature is less than a threshold temperature, and whether or not engine oil temperature is less than a threshold temperature. If at least one of the respective temperatures is less than the threshold temperatures, method 400 proceeds to 410. Otherwise, method 400 proceeds to 420.

At 410, method 400 judges whether or not a glow plug operational timer is less than a threshold amount of time. In one example, the glow plug operational timer is based on empirically determined glow plug operating times that are functions of engine coolant temperature, engine cylinder head temperature, and engine oil temperature. For example, functions or tables may be indexed by engine coolant temperature, engine cylinder head temperature, and engine oil temperature. The functions each output individual times and the maximum time output from the tables or functions is the threshold amount of time. The glow plug operational timer is started when the glow plugs are activated. If the glow plug operational timer is less than the threshold amount of time, method 400 proceeds to 414. Otherwise, method 400 proceeds to 412.

At 412, method 400 deactivates glow plugs by stopping current from flowing to the glow plugs. In this way, glow plugs may be turned off when benefit of operating the glow plugs is diminished. Such operation may improve fuel economy since a load of an alternator coupled to the engine may be reduced when glow plugs are deactivated. Method 400 proceeds to 420 after glow plugs are deactivated.

At 414, method 400 judges whether or not glow plugs are presently on or activated. Glow plugs may be determined to be on when a bit in memory is asserted. If glow plugs are determined to be on or activated, method 400 proceeds to 420. Otherwise, method 400 proceeds to 416.

At 416, method 400 activates glow plugs. Glow plugs may be activated by supplying current to the glow plugs. A battery and/or alternator may supply current to the glow plugs. Method 400 proceeds to 418 after the glow plugs are activated.

At 418, method 400 resets a glow plug operational timer. The glow plug operational timer may start at zero and increase with time after being reset. Method 400 proceeds to 420 after the glow plug timer is reset.

At 420, method 400 judges whether or not a grid heater operational timer is less than a threshold amount of time. In one example, the grid heater operational timer is based on empirically determined grid heater operating times that are functions of engine coolant temperature, engine cylinder head temperature, and engine oil temperature. For example, functions or tables may be indexed by engine coolant temperature, engine cylinder head temperature, and engine oil temperature. The functions each output individual times and the maximum time output from the tables or functions is the threshold amount of time. The grid heater operational timer is started when the grid heater is activated. If the grid heater operational timer is less than the threshold amount of time, method 400 proceeds to 424. Otherwise, method 400 proceeds to 422.

At 422, method 400 deactivates the grid heater by stopping current from flowing to the grid heater. In this way, the grid heater may be turned off when benefit of operating the grid heater is diminished. Such operation may improve fuel economy since a load of an alternator coupled to the engine may be reduced when the grid heater is deactivated. Method 400 proceeds to exits after the grid heater is deactivated.

At 424, method 400 judges whether or not the grid heater is presently on or activated. The grid heater may be determined to be on when a bit in memory is asserted. If the grid heater is determined to be on or activated, method 400 proceeds to exit. Otherwise, method 400 proceeds to 426.

At 426, method 400 activates the grid heater. The grid heater may be activated by supplying current to the grid heater. A battery and/or alternator may supply current to the grid heater. Method 400 proceeds to 428 after the grid heater is activated.

At 428, method 400 resets a grid heater timer. The grid heater timer may start at zero and increase with time after being reset. Method 400 proceeds to exit after the grid heater timer is reset.

Thus, the method of FIG. 4 provides for operating an engine, comprising: automatically stopping an engine without a dedicated driver request to stop the engine; and selectively activating a first heater that heats contents of an engine cylinder during an automatic engine start, the automatic engine start initiated without a dedicated driver engine start request. The method includes where the first heater is a glow plug. The method includes where the first heater is an air inlet grid heater. In this way, glow plugs and a grid heater of a vehicle can be operated for an engine that is automatically stopped and started to improve engine emissions and combustion stability during starting conditions.

In some examples, the method includes where the first heater is not activated after engine warm-up during conditions where the engine is successively automatically stopped and automatically started within a predetermined period of time. The method also includes where the predetermined amount of time is varied with ambient environmental conditions. The method further comprises selectively activating a second heater and heating contents of the engine cylinder during the automatic engine start. The method also includes where the first heater is a glow plug and where the second heater is an air inlet grid heater.

The method of FIG. 4 also provides for operating an engine, comprising: starting the engine via activating a first heater that heats contents of a cylinder during an operator initiated engine start; automatically stopping an engine without a dedicated driver request to stop the engine; and selectively activating the first heater and heating contents of an engine cylinder in response to an automatic engine start request, the automatic engine start request initiated without a dedicated driver engine start request, the first heater activated in further response to a temperature of the engine. The method further comprises selectively activating a second heater and heating contents of the engine cylinder in response to the automatic engine start request.

In some examples, the method includes where the first heater is a glow plug and where the second heater is an air inlet glow plug. The method also includes where the temperature of the engine is at least one of an engine coolant temperature, an engine oil temperature, and an engine cylinder head temperature. The method further comprises activating the first heater and the second heater for different durations. The method also includes where the first heater and the second heater are not activated in response to the automatic engine start request when a duration between when the engine is automatically stopped and when the automatic engine start request is received is less than a threshold amount of time. The method includes where the first heater is not deactivated during the automatic stopping of the engine.

As will be appreciated by one of ordinary skill in the art, the method described in FIG. 4 may represent one or more of any number of processing strategies such as event-driven, interrupt-driven, multi-tasking, multi-threading, and the like. As such, various steps or functions illustrated may be performed in the sequence illustrated, in parallel, or in some cases omitted. Likewise, the order of processing is not necessarily required to achieve the objects, features, and advantages described herein, but is provided for ease of illustration and description. Although not explicitly illustrated, one of ordinary skill in the art will recognize that one or more of the illustrated steps, methods, or functions may be repeatedly performed depending on the particular strategy being used.

This concludes the description. The reading of it by those skilled in the art would bring to mind many alterations and modifications without departing from the spirit and the scope of the description. For example, single cylinder, I2, I3, I4, I5, V6, V8, V10, V12 and V16 engines operating in natural gas, gasoline, diesel, or alternative fuel configurations could use the present description to advantage.

1. A method for operating an engine, comprising:
automatically stopping an engine without a dedicated driver request to stop the engine; and
selectively activating a first heater that heats contents of an engine cylinder during an automatic engine start, the automatic engine start initiated without a dedicated driver engine start request.

2. The method of claim 1, where the first heater is a glow plug.

3. The method of claim 1, where the first heater is an air inlet grid heater.

4. The method of claim 1, where the first heater is not activated after engine warm-up during conditions where the engine is successively automatically stopped and automatically started within a predetermined period of time.

5. The method of claim 4, where the predetermined amount of time is varied with ambient environmental conditions.

6. The method of claim 1, further comprising selectively activating a second heater and heating contents of the engine cylinder during the automatic engine start.

7. The method of claim 6, where the first heater is a glow plug and where the second heater is an air inlet grid heater.

8. A method for operating an engine, comprising:
starting the engine via activating a first heater that heats contents of a cylinder during an operator initiated engine start;
automatically stopping an engine without a dedicated driver request to stop the engine; and
selectively activating the first heater and heating contents of an engine cylinder in response to an automatic engine start request, the automatic engine start request initiated without a dedicated driver engine start request, the first heater activated in further response to a temperature of the engine.

9. The method of claim 8, further comprising selectively activating a second heater and heating contents of the engine cylinder in response to the automatic engine start request.

10. The method of claim 9, where the first heater is a glow plug and where the second heater is an air inlet glow plug.

11. The method of claim 8, where the temperature of the engine is at least one of an engine coolant temperature, an engine oil temperature, and an engine cylinder head temperature.

12. The method of claim 9, further comprising activating the first heater and the second heater for different durations.

13. The method of claim 9, where the first heater and the second heater are not activated in response to the automatic engine start request when a duration between when the engine is automatically stopped and when the automatic engine start request is received is less than a threshold amount of time.

14. The method of claim 8, where the first heater is not deactivated during the automatic stopping of the engine.

15. A system, comprising:
an engine;
a glow plug positioned in a cylinder of the engine;
a dedicated driver operated engine starting input device;
a driver vehicle control input device; and
a controller including instructions to start the engine in response to an operator changing a state of the dedicated driver operated engine starting input device, and instructions to automatically activate the glow plug and start the engine without the operator changing the state of the dedicated driver operated engine starting input device and in response to a state of the driver vehicle control input device.

16. The system of claim 15, where the driver vehicle control input device is a brake pedal or an accelerator pedal.

17. The system of claim 15, further comprising a grid heater and further controller instructions for automatically activating the grid heater and start the engine without the operator changing the state of the dedicated driver operated engine starting input device and in response to the state of the driver vehicle control input device.

18. The system of claim 15, further comprising additional controller instructions to not activate the glow plug during automatic engine starting where the operator has not changed the state of the dedicated driver operated engine starting input device.

19. The system of claim 18, further comprising additional controller instructions to automatically stop the engine.

20. The system of claim 19, further comprising additional controller instructions to selectively activate the glow plug in response to a temperature of the engine during automatic engine starting.
